(19) United States
(12) Patent Application Publication
(10) Pub. No.: US 2025/0237300 A1
(43) Pub. Date: Jul. 24, 2025

(54) OPTIMIZATION METHOD FOR TOOTH PROFILE MODIFICATION OF CYCLOID GEAR

(71) Applicant: Guangxi University, Nanning (CN)

(72) Inventors: Yong CHEN, Nanning (CN); Fucheng YU, Nanning (CN); Jianyun MO, Nanning (CN); Li LUO, Nanning (CN)

(73) Assignee: Guangxi University, Nanning (CN)

(21) Appl. No.: 19/006,258

(22) Filed: Dec. 31, 2024

(30) Foreign Application Priority Data
Jan. 23, 2024 (CN) 202410091421.3

(51) Int. Cl. F16H 55/08

(52) U.S. Cl. CPC F16H 55/08

(57) ABSTRACT

An optimization method of the tooth profile modification of the cycloid gear is provided, and optimizes the method of equidistant-distance combination modification of the tooth profile of the cycloid gear, with the help of multi-objective optimization algorithm based on pressure angle of tooth profile, curvature radius and contact performance, the working range of the tooth profile modification of the cycloid gear is determined, and the optimal modification amount of the cycloid pin gear planetary reducer is determined, the tooth profile of the cycloid gear is modified to compensate these errors, ensure that it has reasonable tooth side clearance, lubrication and assembly, and improve the transmission efficiency and bearing capacity of the cycloid pin gear planetary reducer. The optimization method has the effects of high precision transmission, low noise operation, improving transmission efficiency, prolonging fatigue life and reducing space occupation.

### CROSS REFERENCE TO THE RELATED APPLICATIONS

This application is based upon and claims priority to Chinese Patent Application No. 202410091421.3, filed on Jan. 23, 2024, the entire contents of which are incorporated herein by reference.

### TECHNICAL FIELD

The invention provides an optimization method for a tooth profile modification of a cycloid gear, which belongs to gear design technology.

### BACKGROUND

The cycloid pin gear planetary reducer is a kind of speed reducer with high precision and high torque output, the transmission system is composed of planetary gear set and cycloid gear. Cycloid gear, the special gear design makes the cycloid gear in high load, high precision, high torque transmission application performance, the tooth profile modification technology of the cycloid gear belongs to the field of mechanical engineering, especially in mechanical design and manufacturing. It involves many aspects of knowledge such as gear design, manufacturing process, and precision machining, it is one of the important technologies developed to improve the performance and reliability of mechanical transmission systems. Through continuous research and innovation, the profile modification technology of the cycloid gear will continue to play an important role in various engineering applications, widely used in industrial robots, aerospace, medical robots, mechanical engineering, and other technical fields.

In recent years, with the improvement of the requirements for high efficiency, high precision retention and high fatigue life transmission devices in the industry, the performance of the cycloid pin gear planetary reducer directly affects the transmission accuracy of the industrial robot, its structure is complex, in the actual working conditions, the cycloid pin gear planetary reducer needs to be accurately positioned repeatedly, if the accuracy is low, it will cause the reducer to wear, therefore, it is necessary to have extremely high precision retention during the continuous start-stop process. The manufacturing of the cycloid gear must be accurate to ensure that the geometry and size of the gear are consistent with the design specifications, any manufacturing error may lead to transmission error and performance degradation, and the meshing of the standard cycloid gear and the pin gear will interfere and cannot form a lubrication gap. Therefore, it is necessary to modify the tooth profile of the cycloid gear to compensate for these errors and ensure that it has reasonable tooth side clearance, lubrication, and assembly.

The problems that may be caused by the tooth profile modification of the cycloid gear include the increase of the tooth side clearance, which will lead to the reduction of the number of meshing teeth between the pin tooth and the cycloid gear, thus reducing the overall bearing capacity of the cycloid pin gear planetary reducer, and may even lead to serious problems such as pin tooth wear and fracture, which will eventually lead to the failure of the entire reducer. Therefore, the amount of modification must be carefully controlled to reduce the occurrence of these potential problems when modifying the tooth profile of the cycloid gear. Generally speaking, there are three common tooth profile modification methods for cycloid gears: equidistant modification, shift distance modification, and angle modification. In actual production, engineers and technicians usually use similar methods to determine the amount of modification, but there is no mature theoretical support for small-scale modification. Therefore, optimizing the tooth profile modification of the cycloid gears needs further analysis and research.

The tooth profile modification of cycloid gears has the best working range, the purpose of the modification is to ensure that the modified tooth profile has a certain meshing gap, which is convenient for lubrication and meshing, and must have a certain amount of modification, the standard tooth profile of the cycloid gear is too large due to the coincidence degree, and the cycloid gear and the pin gear cannot be normally engaged and transmitted, therefore, if the tooth profile modification amount of the cycloid gear is too small, it will lead to a smaller meshing clearance, which will lead to a close coincidence between the modified tooth profile and the theoretical tooth profile, resulting in abnormal meshing transmission. When the tooth profile modification amount of the cycloid gear is larger, the initial meshing clearance is larger, although it is beneficial to lubrication and lubricating oil storage to a certain extent, the excessive clearance will have a more adverse effect on the meshing characteristics and transmission error of the cycloid gear tooth profile, resulting in low transmission efficiency, poor precision retention, and short fatigue life.

### SUMMARY

In view of the above technical problems, the invention provides an optimization method for a tooth profile modification of a cycloid gear, and optimizes the method of equidistant-distance combination modification of the tooth profile of the cycloid gear, with the help of a multi-objective optimization algorithm based on pressure angle of tooth profile, curvature radius and contact performance, the working range of the tooth profile modification of the cycloid gear is determined, and the optimal modification amount of the cycloid pin gear planetary reducer is determined, the tooth profile of the cycloid gear is modified to compensate these errors, ensure that it has reasonable tooth side clearance, lubrication and assembly, and improve the transmission efficiency and bearing capacity of the cycloid pin gear planetary reducer.

The specific technical solution is as follows:

Obtaining a standard tooth profile equation of a cycloid gear.

Obtaining a pressure angle of a tooth profile of the cycloid gear. Determining a distribution law of the pressure angle of the cycloid gear in order to obtain a position of a minimum pressure angle of the cycloid gear.

Solving and obtaining a modification amount of positive equidistant+negative shift distance, and transforming the cycloid gear into a reverse bow curve tooth profile by using its modification.

Solving and obtaining a tooth profile equation of the cycloid gear under a modification mode of positive equidistant+negative shift distance.

The standard tooth profile equation of the cycloid gear is as follows:

$${x}_{c} = [ ( {r}_{p} - {r}_{rp} {ϕ}^{- 1} ( {K}_{1} , φ ) ] cos ( 1 - {i}^{H} ) φ - [ a - {K}_{1} {r}_{rp} {ϕ}^{- 1} ( {K}_{1} , φ ) ] cos ( {i}^{H} φ )$$

$${y}_{c} = [ ( {r}_{p} - {r}_{rp} {ϕ}^{- 1} ( {K}_{1} , φ ) ] sin ( 1 - {i}^{H} ) φ + [ a - {K}_{1} {r}_{rp} {ϕ}^{- 1} ( {K}_{1} , φ ) ] sin ( {i}^{H} φ )$$

Zₚ—number of teeth of a pin gear;
Z—number of teeth of the cycloid gear;
rₚ—radius of a pin tooth distribution circle;
rᵣₚ—radius of a pin tooth;
a—eccentricity;
K₁—short width coefficient, K₁=aZₚ/rₚ=(r_{c}+a)/rₚ;
i_{H}—relative transmission ratio of the cycloid gear and the pin gear i^{H}=ω_{c}^{H}/ω_{P}^{H}=Zₚ/Z_{c};
a coordinate system XOₚY is fixedly connected to a rotating arm OₚO_{c}, the coordinate system XOₚY is a static coordinate system;
a coordinate system Xₚ OₚYₚ is fixedly connected to the pin gear;
X_{C}OₚY_{C} is fixedly connected to the cycloid gear;

$$S = 1 + {K}_{1}^{2} - 2 {K}_{1} cos φ$$

$${φ}^{- 1} ( {K}_{1} , φ ) = {( 1 + {K}_{1}^{2} - 2 {K}_{1} cos φ )}^{- \frac{1}{2}}$$

after transformation, the following is obtained:

$${n}_{cx} = {ϕ}^{- 1} ( {K}_{1} , φ ) [ - sin ( 1 - {i}^{H} ) φ - {K}_{1} sin ( {i}^{H} φ ) ]$$

$${n}_{cy} = {ϕ}^{- 1} ( {K}_{1} , φ ) [ - cos ( 1 - {i}^{H} ) φ + {K}_{1} cos ( {i}^{H} φ ) ]$$

pin tooth profile equation:

$${R}_{px} = - \frac{{r}_{p} {K}_{1} sin {ϕ}_{1}}{ϕ ( {K}_{1} , φ )} I$$

$${R}_{py} = {r}_{p} - \frac{{r}_{p} ( 1 - cos {ϕ}_{1} )}{ϕ ( {K}_{1} , ϕ )}$$

the pressure angle of tooth profile of the cycloid gear is:

$$α = arccos \vert ( \vec{{n}_{c}} \cdot \vec{{V}_{c}} ) \vert = arccos \frac{{V}_{c} {n}_{c}}{\vert {V}_{c} \vert}$$

α—pressure angle of tooth profile;
\vec{n_{c}} is a unit vector of a public normal line;
\vec{V_{c}} is a unit vector of a cycloid gear speed;
solving a function curve of a meshing phase angle of the cycloid gear:
the meshing phase angle α is related to the setting of the pin tooth number nᵢ, (nᵢ is counted from a symmetrical axis of a tooth groove of the cycloid gear).

$$φ = \frac{2 π {n}_{i}}{{Z}_{c}} - arccos ( \frac{{r}_{c}^{′2} + \frac{{λ}^{2} {r}_{p}^{2} {sin}^{2} α}{{( 1 + λ )}^{2}} + {( \frac{{r}_{p}^{′} + λ {r}_{p} cos α}{1 + λ} - a )}^{2} - {λ}^{2} - {r}_{rp}^{2}}{2 {r}_{c}^{′2} \sqrt{\frac{{λ}^{2} {r}_{p}^{2} {sin}^{2} α}{{( 1 + λ )}^{2}} + {( \frac{{r}_{p}^{′} + λ {r}_{p} cos α}{1 + λ} - a )}^{2}}} )$$

in the formula:
rₚ—radius of the pin gear distribution circle;
rᵣₚ—radius of pin tooth;
r′ₚ—radius of a pin gear pitch circle;
r′_{c}=aZ_{c};
r′ₚ=aZₚ;

$$α = \frac{2 π {n}_{i}}{{Z}_{p}} ;$$

$$λ = \frac{{r}_{p} {φ}^{- 1} ( {K}_{1} , φ )}{{r}_{rp}} - 1 ;$$

it is assumed that the cycloid gear pin tooth number when the cycloid gear begins to contact is nₐ, and the final cycloid gear pin tooth number when the meshing is withdrawn is n_{b}, the actual working range of the cycloid gear is small, it can be seen from the function curve of a meshing phase angle of the cycloid gear calculated by this example that the curvature change of the meshing phase angle is relatively gentle within the range of nᵢ=1˜7, that is, the change of the corresponding meshing phase angle φ is small. Therefore, in this range, the relative motion distance between the cycloid gear and the pin tooth is small, and the working area of the cycloid gear is small, which is conducive to reducing the friction loss in the meshing process and improving the transmission efficiency.

According to a tooth profile modification equation, obtaining a tooth profile equation of a modified cycloid gear:

$${x}_{c}^{′} = [ ( {r}_{p} + Δ {r}_{p} ) - ( {r}_{rp} + Δ {r}_{rp} ) {ϕ}^{′ - 1} ( {K}_{2} , φ ) ] cos ( 1 - {i}^{H} ) φ - [ a - {K}_{2} ( {r}_{rp} + Δ {r}_{rp} ) {ϕ}^{′ - 1} ( {K}_{2} , φ ) ] cos ( {i}^{H} φ )$$

$${y}_{c}^{′} = [ ( ( {r}_{p} + Δ {r}_{p} ) - ( {r}_{rp} + Δ {r}_{rp} ) {ϕ}^{′ - 1} ( {K}_{2} , φ ) ] sin ( 1 - {i}^{H} ) φ + [ a - {K}_{2} ( {r}_{rp} + Δ {r}_{rp} ) {ϕ}^{′ - 1} ( {K}_{2} , φ ) ] sin ( {i}^{H} φ )$$

K₂—short width coefficient after modification, K₂=aZₚ/(rₚ+Δrₚ);

$${S}^{′} = 1 + {K}_{2}^{2} - 2 {K}_{2} cos φ$$

$${φ}^{′ - 1} ( {K}_{2} , φ ) = {( 1 + {K}_{2}^{2} - 2 {K}_{2} cos φ )}^{- \frac{1}{2}}$$

solving and obtaining a transmission and meshing stiffness calculation of the cycloid pin gear:
according to Hertz contact theory:

$$d = \sqrt{\frac{8 {F}_{i} {ρ}_{i} ( 1 - {μ}^{2} )}{π bE}}$$

$$\frac{1}{{ρ}_{i}} = \frac{1}{{r}_{rp}} \pm \vert \frac{T}{{r}_{p} S + {Tr}_{rp}} \vert$$

radial extrusion deformation of pin gear:

$${t}_{z} = {r}_{rp} [ 1 - \sqrt{1 - {( \frac{d}{{r}_{rp}} )}^{2}} ] = \frac{4 {F}_{i} {ρ}_{i} ( 1 - {μ}^{2} )}{π {bEr}_{rp}}$$

radial extrusion deformation of cycloid gear:

$${t}_{b} = \frac{4 {F}_{i} {ρ}_{i} ( 1 - {μ}^{2} ) T}{π bE ( {r}_{p} S + {Tr}_{rp} )}$$

meshing stiffness of a single pair of gears:

$$k = \frac{π {bEr}_{p} {S}^{3 / 2}}{4 ( 1 - {μ}^{2} ) ( {r}_{p} {S}^{3 / 2} + {r}_{rp} Z + {r}_{rp} \vert Z \vert}$$

in the formula,

$$Z = {K}_{1} ( 1 + {Z}_{b} ) cos ( {φ}_{i} ) - ( 1 + {Z}_{b} {{K}_{1}}^{2} ) ;$$

E—elastic modulus of materials of the cycloid gear and the pin gear;
μ—Poisson's ratio of the materials of the cycloid gear and the pin gear;
d—deformation area of the meshing of the cycloid gear and the pin gear;
b—widths of the cycloid gear and the pin gear.

Finally, the working range of the tooth profile modification of the cycloid gear and the optimal modification amount of the cycloid pin gear planetary reducer are determined, and the cycloid gear tooth profile is modified to compensate these errors to ensure that it has reasonable tooth side clearance, lubrication and assembly.

The technical effect of the invention is as follows:
1. High-precision transmission: In the mechanical transmission system, the accuracy requirements are very high, especially in the field of precision machinery, such as robots, CNC machine tools. The tooth profile modification of the cycloid gear can effectively reduce the pitch error of the gear and improve the accuracy and stability of the transmission, so as to meet the needs of high-precision transmission.
2. Low-noise operation: The tooth profile modification of the cycloid gear can reduce the meshing impact on gear tooth surface and reduce the noise level of transmission system. This is of great significance for applications that require low-noise operation, such as medical equipment, audio equipment, etc.
3. Improving transmission efficiency: The tooth profile modification of the cycloid gear can improve the gear meshing, reduce energy loss and improve the transmission efficiency. This is particularly important in industrial equipment and automotive transmission systems that require energy conservation.
4. Prolonging fatigue life: By reducing the wear and fatigue of the gear, the tooth profile modification of the cycloid gear can significantly extend the service life of the transmission system and reduce maintenance costs.
5. Reducing space occupation: The tooth profile modification of the cycloid gear can achieve a more compact transmission design, reduce the space occupation of the transmission device, and make it suitable for applications in limited space, such as robot joints and aircraft landing gears.

### BRIEF DESCRIPTION OF THE DRAWINGS

FIG. 1 is a profile curve of the cycloid gear-pin gear tooth profile curve in the embodiment;

FIG. 2 is a flowchart of the tooth profile modification of the cycloid gear;

FIG. 3 is a standard tooth profile equation of the cycloid gear s of the implementation example;

FIG. 4 is an equidistant+shift distance modification curve of the cycloid gear in the embodiment.

FIG. 5 is a distribution law of the rotation angle of the cycloid gear and the pin gear and the pressure angle of the tooth profile;

FIG. 6 is a function curve of the meshing phase angle of the cycloid gear in the embodiment.

### DETAILED DESCRIPTION OF THE EMBODIMENTS

The specific technical scheme of the invention is illustrated with the attached figures.

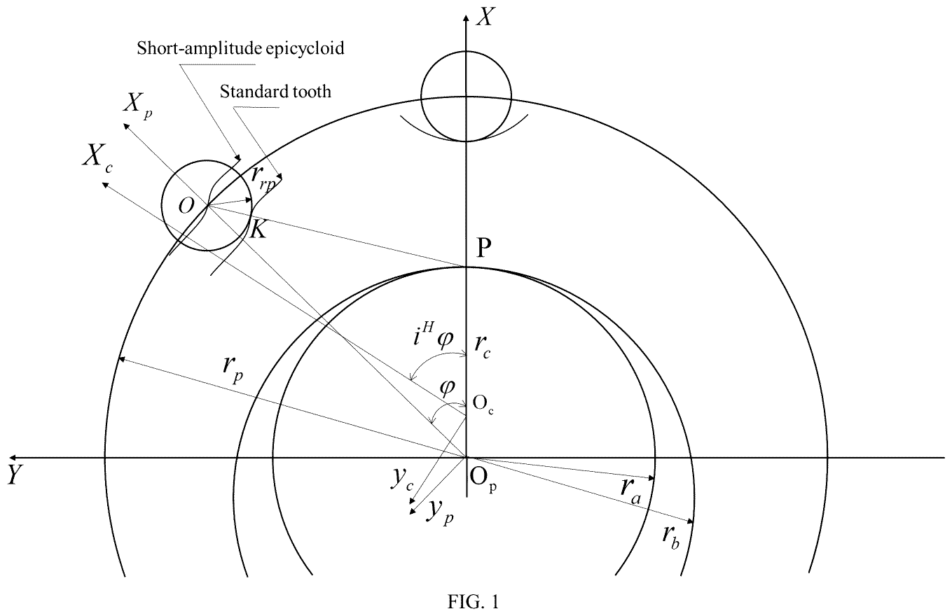

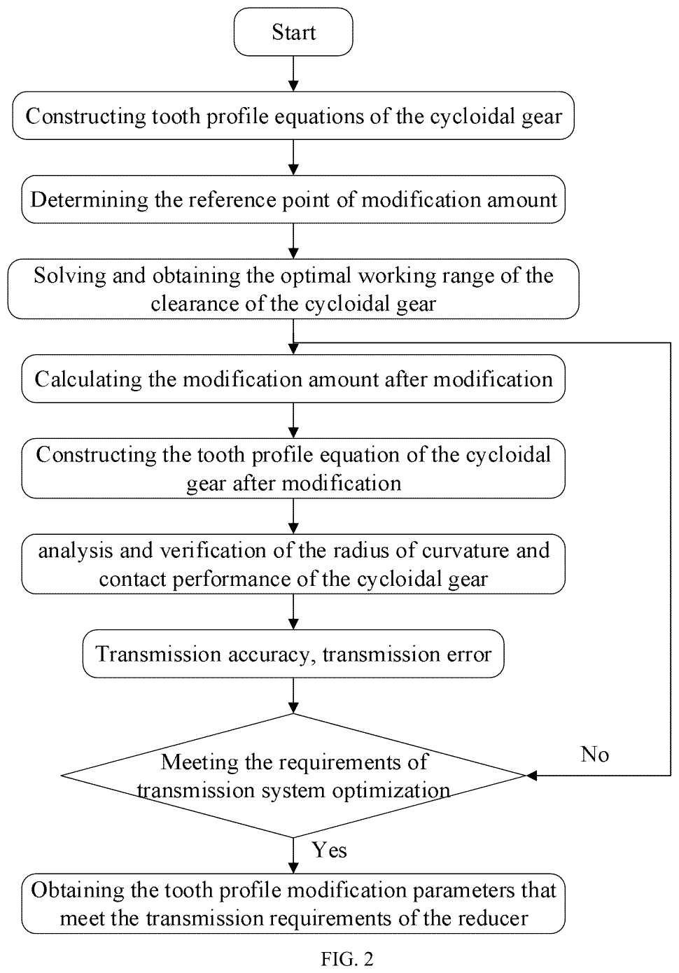

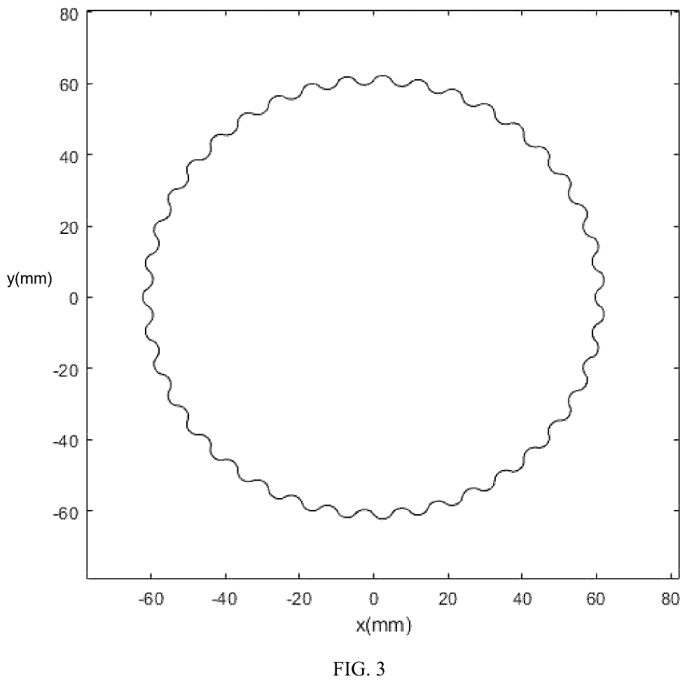

As shown in FIG. 1, it is an analysis diagram for solving the tooth profile curve of the cycloid gear-pin gear. As shown in FIG. 3, the tooth profile curve of the cycloid gear-pin gear is solved according to FIG. 1 and generated in matlab, the method for solving the tooth profile modification of cycloid gear-pin gear adopts the steps shown in FIG. 2:

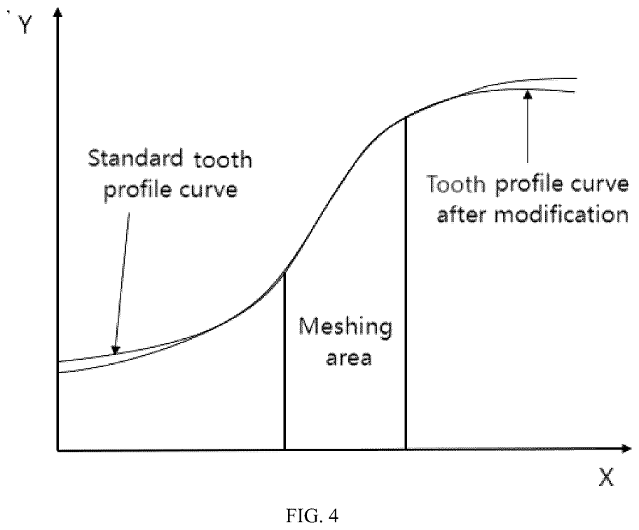

As shown in FIG. 4, it is the standard tooth profile equation that the equidistant+shift distance principle analysis diagram of the cycloid gear implements to obtain the standard of the cycloid gear, as shown in FIG. 3.

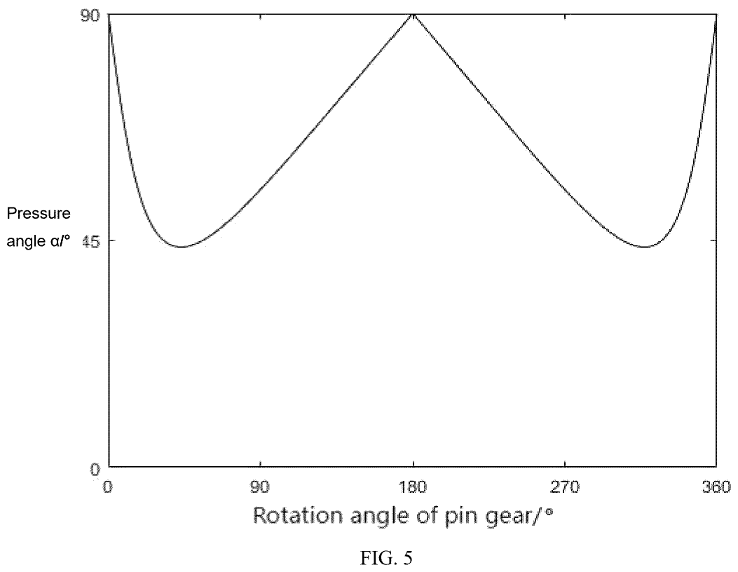

As shown in FIG. 5, the pressure angle curve of the tooth profile of the cycloid gear is used to determine the distribution law of the pressure angle of the cycloid gear, and the change of the pressure angle of the tooth profile is determined according to the modification amount to obtain the position of the minimum pressure angle of the cycloid gear.

The modification amount of positive equidistant+negative shift distance is obtained, and the cycloid gear is transformed into a reverse bow curve tooth profile by using its modification.

As shown in FIG. 4, the tooth profile equation of cycloid gear under the modification mode of positive equidistant+negative shift distance is obtained.

The standard tooth profile equation of cycloid gear is as follows:

$${x}_{c} = [ ( {r}_{p} - {r}_{rp} {ϕ}^{- 1} ( {K}_{1} , φ ) ] cos ( 1 - {i}^{H} ) φ - [ a - {K}_{1} {r}_{rp} {ϕ}^{- 1} ( {K}_{1} , φ ) ] cos ( {i}^{H} φ )$$

$${y}_{c} = [ ( {r}_{p} - {r}_{rp} {ϕ}^{- 1} ( {K}_{1} , φ ) ] sin ( 1 - {i}^{H} ) φ + [ a - {K}_{1} {r}_{rp} {ϕ}^{- 1} ( {K}_{1} , φ ) ] sin ( {i}^{H} φ )$$

Zₚ—number of the teeth of the pin gear;
Z_{c}—number of the teeth of the cycloid gear;
rₚ—radius of the pin tooth distribution circle;
rᵣₚ—radius of the pin tooth;
a—eccentricity;
K₁-short width coefficient, K₁=aZₚ/rₚ=(r_{c}+a)/rₚ;
i^{H}—relative transmission ratio of the cycloid gear and the pin gear i^{H}=ω_{c}^{H}/ω_{P}^{H}=Zₚ/Z_{c};
the coordinate system XOₚY is fixedly connected to the rotating arm OₚO_{c}, the coordinate system XOₚY is the static coordinate system;
the coordinate system XₚOₚYₚ is fixedly connected to the pin gear;
X_{C}OₚY_{C} is fixedly connected to the cycloid gear;

$$S = 1 + {K}_{1}^{2} - 2 {K}_{1} cos φ$$

$${φ}^{- 1} ( {K}_{1} , φ ) = {( 1 + {K}_{1}^{2} - 2 {K}_{1} cos φ )}^{- \frac{1}{2}}$$

after transformation, the following is obtained:

$${n}_{cx} = {ϕ}^{- 1} ( {K}_{1} , φ ) [ - sin ( 1 - {i}^{H} ) φ - {K}_{1} sin ( {i}^{H} φ ) ]$$

$${n}_{cy} = {ϕ}^{- 1} ( {K}_{1} , φ ) [ - cos ( 1 - {i}^{H} ) φ + {K}_{1} cos ( {i}^{H} φ ) ]$$

the pin tooth profile equation:

$${R}_{px} = - \frac{{r}_{p} {K}_{1} sin {ϕ}_{1}}{ϕ ( {K}_{1} , φ )} I$$

$${R}_{py} = {r}_{p} - \frac{{r}_{p} ( 1 - cos {ϕ}_{1} )}{ϕ ( {K}_{1} , φ )}$$

the pressure angle of the tooth profile of the cycloid gear is:

$$α = arccos \vert ( \vec{{n}_{c}} \cdot \vec{{V}_{c}} ) \vert = arccos \frac{{V}_{c} {n}_{c}}{\vert {V}_{c} \vert}$$

α—the pressure angle of the tooth profile;
\vec{n_{c}} is the unit vector of the public normal line;
V̅_̅{̅c̅}̅ is the unit vector of the cycloid gear speed;

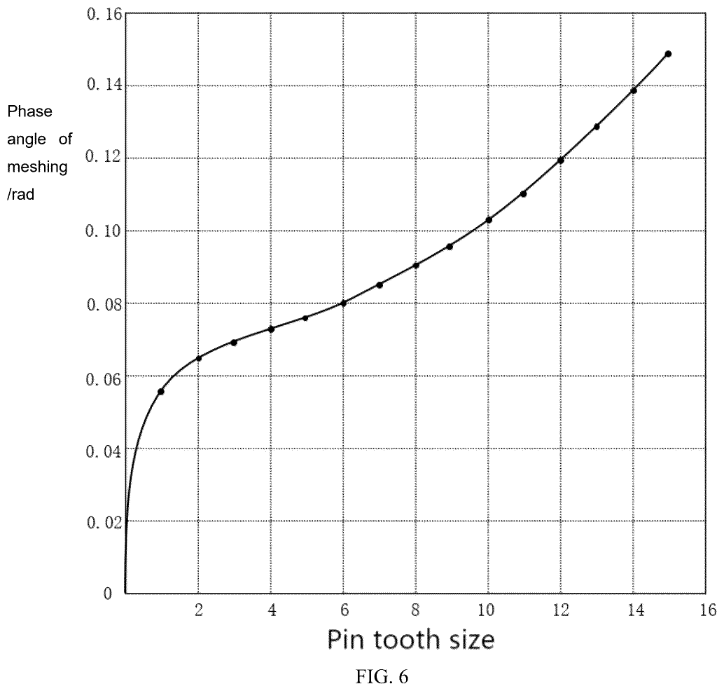

The following formula is to solve the function curve of the meshing phase angle of the cycloid gear, as shown in FIG. 6, it is the change curve of the meshing phase angle, according to the meshing phase angle and the pressure angle of tooth profile after modification, the optimal modification amount is obtained:

The meshing phase angle α is related to the setting of the pin tooth number nᵢ, (nᵢ is counted from the symmetrical axis of the tooth groove of the cycloid gear).

$$φ = \frac{2 π {n}_{i}}{{Z}_{c}} - arccos ( \frac{{r}_{c}^{′2} + \frac{{λ}^{2} {r}_{p}^{2} {sin}^{2} α}{{( 1 + λ )}^{2}} + {( \frac{{r}_{p}^{′} + λ {r}_{p} cos α}{1 + λ} - a )}^{2} - {λ}^{2} - {r}_{rp}^{2}}{2 {r}_{c}^{′2} \sqrt{\frac{{λ}^{2} {r}_{p}^{2} {sin}^{2} α}{{( 1 + λ )}^{2}} + {( \frac{{r}_{p}^{′} + λ {r}_{p} cos α}{1 + λ} - a )}^{2}}} )$$

in the formula:
rₚ—radius of the pin gear distribution circle;
rᵣₚ—radius of pin tooth;
r′ₚ—radius of a pin gear pitch circle;
r′_{c}=aZ_{c};
r′ₚ=aZₚ;

$$\begin{matrix}α = \frac{2 π {n}_{i}}{{Z}_{p}} ; \\ λ = \frac{{r}_{p} {φ}^{- 1} ( {K}_{1} , φ )}{{r}_{r p}} - 1 ;\end{matrix}$$

it is assumed that the cycloid gear pin tooth number when the cycloid gear begins to contact is nₐ, and the final cycloid gear pin tooth number when the meshing is withdrawn is n_{b}, the actual working range of the cycloid gear is small, it can be seen from the function curve of a meshing phase angle of the cycloid gear calculated by this example that the curvature change of the meshing phase angle is relatively gentle within the range of nᵢ=1˜7, that is, the change of the corresponding meshing phase angle φ is small. Therefore, in this range, the relative motion distance between the cycloid gear and the pin tooth is small, and the working area of the cycloid gear is small, which is conducive to reducing the friction loss in the meshing process and improving the transmission efficiency.

The following formula is the tooth profile equation after the equidistant+shift distance modification:

$${x}_{c}^{′} = [ ( {r}_{p} + Δ {r}_{p} ) - ( {r}_{rp} + Δ {r}_{rp} ) {ϕ}^{′ - 1} ( {K}_{2} , φ ) ] cos ( 1 - {i}^{H} ) φ - [ a - {K}_{2} ( {r}_{rp} + Δ {r}_{rp} ) {ϕ}^{′ - 1} ( {K}_{2} , φ ) ] cos ( {i}^{H} φ )$$

$${y}_{c}^{′} = [ ( ( {r}_{p} + Δ {r}_{p} ) - ( {r}_{rp} + Δ {r}_{rp} ) {ϕ}^{′ - 1} ( {K}_{2} , φ ) ] sin ( 1 - {i}^{H} ) φ + [ a - {K}_{2} ( {r}_{rp} + Δ {r}_{rp} ) {ϕ}^{′ - 1} ( {K}_{2} , φ ) ] sin ( {i}^{H} φ )$$

K₂—short width coefficient after modification, K₂=aZₚ/(rₚ+Δrₚ);

$${S}^{′} = 1 + {K}_{2}^{2} - 2 {K}_{2} cos φ$$

$${φ}^{′ - 1} ( {K}_{2} , φ ) = {( 1 + {K}_{2}^{2} - 2 {K}_{2} cos φ )}^{- \frac{1}{2}}$$

the transmission and meshing stiffness calculation of the cycloid pin gear is solved and obtained:
according to Hertz contact theory:

$$d = \sqrt{\frac{8 {F}_{i} {ρ}_{i} ( 1 - {μ}^{2} )}{π bE}}$$

$$\frac{1}{{ρ}_{i}} = \frac{1}{{r}_{rp}} \pm \vert \frac{T}{{r}_{p} S + {Tr}_{rp}} \vert$$

radial extrusion deformation of the pin gear:

$${t}_{z} = {r}_{rp} [ 1 - \sqrt{1 - {( \frac{d}{{r}_{rp}} )}^{2}} ] = \frac{4 {F}_{i} {ρ}_{i} ( 1 - {μ}^{2} )}{π {bEr}_{rp}}$$

radial extrusion deformation of the cycloid gear:

$${t}_{b} = \frac{4 {F}_{i} {ρ}_{i} ( 1 - {μ}^{2} ) T}{π bE ( {r}_{p} S + {Tr}_{rp} )}$$

meshing stiffness of a single pair of gears:

$$k = \frac{π {bEr}_{p} {S}^{3 / 2}}{4 ( 1 - {μ}^{2} ) ( {r}_{p} {S}^{3 / 2} + {r}_{rp} Z + {r}_{rp} \vert Z \vert}$$

in the formula,

$$Z = {K}_{1} ( 1 + {Z}_{b} ) cos ( {φ}_{i} ) - ( 1 + {Z}_{b} {K}_{1}^{2} ) ;$$

E—elastic modulus of materials of the cycloid gear and the pin gear;
μ—Poisson's ratio of the materials of the cycloid gear and the pin gear;
d—deformation area of the meshing of the cycloid gear and the pin gear;
b—widths of the cycloid gear and the pin gear.

Finally, the working range of the tooth profile modification of the cycloid gear and the optimal modification amount of the cycloid pin gear planetary reducer are determined, the tooth profile of the cycloid gear is modified to compensate these errors, ensure that it has reasonable tooth side clearance, lubrication and assembly.

What is claimed is:

1. An optimization method for a tooth profile modification of a cycloid gear, comprising the following steps: optimizing a method of an equidistant-distance combination modification of a tooth profile of the cycloid gear, with a help of a multi-objective optimization algorithm based on a pressure angle of the tooth profile, a curvature radius, and a contact performance, determining a working range of the tooth profile modification of the cycloid gear, and determining an optimal modification amount of a cycloid pin gear planetary reducer, modifying the tooth profile of the cycloid gear to compensate errors, ensuring that the cycloid gear has reasonable tooth side clearance, lubrication, and assembly, and improving a transmission efficiency and a bearing capacity of the cycloid pin gear planetary reducer.

2. The optimization method for the tooth profile modification of the cycloid gear according to claim 1, wherein steps are as follows:
step 1: obtaining a standard tooth profile equation of the cycloid gear;
step 2: obtaining the pressure angle of the tooth profile of the cycloid gear; and determining a distribution law of a pressure angle of the cycloid gear to obtain a position of a minimum pressure angle of the cycloid gear;
step 3: solving and obtaining a modification amount of a positive equidistant+negative shift distance, and transforming the cycloid gear into a reverse bow curve tooth profile by using a modification;
step 4: solving and obtaining a tooth profile equation of the cycloid gear under a modification mode of the positive equidistant+negative shift distance;
step 5: wherein the standard tooth profile equation of the cycloid gear is as follows:
$${x}_{c} = [ ( {r}_{p} - {r}_{rp} {ϕ}^{- 1} ( {K}_{1} , φ ) ] cos ( 1 - {i}^{H} ) φ - [ a - {K}_{1} {r}_{rp} {ϕ}^{- 1} ( {K}_{1} , φ ) ] cos ( {i}^{H} φ ) \\ {y}_{c} = [ ( {r}_{p} - {r}_{rp} {ϕ}^{- 1} ( {K}_{1} , φ ) ] sin ( 1 - {i}^{H} ) φ + [ a - {K}_{1} {r}_{rp} {ϕ}^{- 1} ( {K}_{1} , φ ) ] sin ( {i}^{H} φ )$$
Zₚ—a number of teeth of a pin gear;
Z_{c}—a number of teeth of the cycloid gear;
rₚ—a radius of a pin tooth distribution circle;
rᵣₚ—a radius of a pin tooth;
a—an eccentricity;
K₁—a short width coefficient, K₁=aZₚ/rₚ=(r_{c}+a)/rₚ;
i^{H}—a relative transmission ratio of the cycloid gear and the pin gear i^{H}=ω_{c}^{H}/ω_{P}^{H}=Zₚ/Z_{c};
wherein a coordinate system XOₚY is fixedly connected to a rotating arm OₚO_{c}, the coordinate system XOₚY is a static coordinate system;
wherein a coordinate system XₚOₚYₚ is fixedly connected to the pin gear;
wherein X_{C}OₚY_{C} is fixedly connected to the cycloid gear;
$$S = 1 + {K}_{1}^{2} - 2 {K}_{1} cos φ \\ {φ}^{- 1} ( {K}_{1} , φ ) = {( 1 + {K}_{1}^{2} - 2 {K}_{1} cos φ )}^{- \frac{1}{2}}$$
step 6: wherein after a transformation, the following is obtained:
$${n}_{cx} = {ϕ}^{- 1} ( {K}_{1} , φ ) [ - sin ( 1 - {i}^{H} ) φ - {K}_{1} sin ( {i}^{H} φ ) ] \\ {n}_{cy} = {ϕ}^{- 1} ( {K}_{1} , φ ) [ - cos ( 1 - {i}^{H} ) φ + {K}_{1} cos ( {i}^{H} φ ) ]$$
step 7: a pin tooth profile equation:
$${R}_{px} = - \frac{{r}_{p} {K}_{1} sin {ϕ}_{1}}{ϕ ( {K}_{1} , φ )} \text{?} \\ {R}_{py} = {r}_{p} - \frac{{r}_{p} ( 1 - cos {ϕ}_{1} )}{ϕ ( {K}_{1} , φ )}$$
$$\text{?} \text{indicates text missing or illegible when filed}$$
step 8: wherein the pressure angle of the tooth profile of the cycloid gear is:
$$α = arc cos \vert ( \vec{{n}_{c}} \cdot {\vec{V}}_{c} ) \vert = arccos \frac{{V}_{c} {n}_{c}}{\vert {V}_{c} \vert}$$
α—the pressure angle of the tooth profile;
\vec{n_{c}} is a unit vector of a public normal line;
\vec{V_{c}} is a unit vector of a cycloid gear speed;
step 9: solving a function curve of a meshing phase angle of the cycloid gear:
wherein the meshing phase angle α is related to setting of a pin tooth number nᵢ, (nᵢ is counted from a symmetrical axis of a tooth groove of the cycloid gear);
$$φ = \frac{2 π {n}_{i}}{{Z}_{c}} - arccos ( \frac{{r}_{c}^{′2} + \frac{{λ}^{2} {r}_{p}^{2} {sin}^{2} α}{{( 1 + λ )}^{2}} + {( \frac{{r}_{p}^{′} + λ {r}_{p} cos α}{1 + λ} - a )}^{2} - {λ}^{2} - {r}_{rp}^{2}}{2 {r}_{c}^{′2} \sqrt{\frac{{λ}^{2} {r}_{p}^{2} {sin}^{2} α}{{( 1 + λ )}^{2}} + {( \frac{{r}_{p}^{′} + λ {r}_{p} cos α}{1 + λ} - a )}^{2}}} )$$
wherein
rₚ—a radius of a pin gear distribution circle;
rᵣₚ—the radius of the pin tooth;
r′ₚ—a radius of a pin gear pitch circle;
r′_{c}=aZ_{c};
r′ₚ=aZₚ;
$$α = \frac{2 π {n}_{i}}{{Z}_{p}} ; \\ λ = \frac{{r}_{p} {φ}^{- 1} ( {K}_{1} , φ )}{{r}_{rp}} - 1 ;$$
step 10: assuming a cycloid gear pin tooth number when the cycloid gear begins to contact is nₐ, and a final cycloid gear pin tooth number when meshing is withdrawn is n_{b};
step 11: according to a tooth profile modification equation, obtaining a tooth profile equation of a modified cycloid gear:
$${x}_{c}^{′} = [ ( {r}_{p} + Δ {r}_{p} ) - ( {r}_{rp} + Δ {r}_{rp} ) {ϕ}^{′ - 1} ( {K}_{2} , φ ) ] cos ( 1 - {i}^{H} ) φ - [ a - {K}_{2} ( {r}_{rp} + Δ {r}_{rp} ) {ϕ}^{′ - 1} ( {K}_{2} , φ ) ] cos ( {i}^{H} φ ) \\ {y}_{c}^{′} = [ ( ( {r}_{p} + Δ {r}_{p} ) - ( {r}_{rp} + Δ {r}_{rp} ) {ϕ}^{′ - 1} ( {K}_{2} , φ ) ] sin ( 1 - {i}^{H} ) φ + [ a - {K}_{2} ( {r}_{rp} + Δ {r}_{rp} ) {ϕ}^{′ - 1} ( {K}_{2} , φ ) ] sin ( {i}^{H} φ )$$
K₂—a short width coefficient after the modification, K₂=aZₚ/(rₚ+Δrₚ);
$${S}^{′} = 1 + {K}_{2}^{2} - 2 {K}_{2} cos φ \\ {φ}^{′ - 1} ( {K}_{2} , φ ) = {( 1 + {K}_{2}^{2} - 2 {K}_{2} cos φ )}^{- \frac{1}{2}}$$
step 12: solving and obtaining a transmission and meshing stiffness calculation of a cycloid pin gear:
step 13: according to Hertz contact theory:
$$d = \sqrt{\frac{8 {F}_{i} {ρ}_{i} ( 1 - {μ}^{2} )}{π bE}} \\ \frac{1}{{ρ}_{i}} = \frac{1}{{r}_{rp}} \pm \vert \frac{T}{{r}_{p} S + T {r}_{rp}} \vert$$
step 14: a radial extrusion deformation of the pin gear:
$${t}_{z} = {r}_{rp} [ 1 - \sqrt{1 - {( \frac{d}{{r}_{rp}} )}^{2}} ] = \frac{4 {F}_{i} {ρ}_{i} ( 1 - {μ}^{2} )}{π {bEr}_{rp}}$$
step 15: a radial extrusion deformation of the cycloid gear:
$${t}_{b} = \frac{4 {F}_{i} {ρ}_{i} ( 1 - {μ}^{2} ) T}{π b E ( {r}_{p} S + T {r}_{rp} )}$$
step 16: a meshing stiffness of a single pair of gears:
$$k = \frac{π b E {r}_{p} {S}^{3 / 2}}{4 ( 1 - {μ}^{2} ) ( {r}_{p} {S}^{3 / 2} + {r}_{rp} Z + {r}_{rp} \vert Z \vert} \\ wherein \\ Z = {K}_{1} ( 1 + {Z}_{b} ) cos ( {φ}_{i} ) - ( 1 + {Z}_{b} {K}_{1}^{2} ) ;$$
E—an elastic modulus of materials of the cycloid gear and the pin gear;
μ—a Poisson's ratio of the materials of the cycloid gear and the pin gear;
d—a deformation area of the meshing of the cycloid gear and the pin gear;
b—widths of the cycloid gear and the pin gear; and
step 17: finally, determining the working range of the tooth profile modification of the cycloid gear and the optimal modification amount of the cycloid pin gear planetary reducer, and modifying the tooth profile of the cycloid gear to compensate the errors to ensure that the cycloid gear has the reasonable tooth side clearance, the lubrication, and the assembly.
